(19) United States
(12) Patent Application Publication
(10) Pub. No.: US 2025/0171174 A1
(43) Pub. Date: May 29, 2025

(54) DEVICE AND METHOD FOR PLACEMENT AND SECUREMENT OF FILM

(71) Applicant: Invitae Corporation, San Francisco, CA (US)

(72) Inventor: David John Guckenberger, JR., Oakland, CA (US)

(73) Assignee: Invitae Corporation, San Francisco, CA (US)

(21) Appl. No.: 18/730,455

(22) PCT Filed: Jan. 12, 2023
(86) PCT No.: PCT/US2023/010649

§ 371 Date: Jul. 19, 2024

Related U.S. Application Data
(60) Provisional application No. 63/301,451, filed on Jan. 20, 2022.

(51) Int. Cl. B65B 7/28; B65B 31/04

(52) U.S. Cl. CPC B65B 7/2842; B65B 31/046

(57) ABSTRACT

An assembly for securing a film to an object is provided. The assembly may comprise a lid comprising a surface configured to receive the film, where the surface comprises a plurality of vent openings through which positive pressure or vacuum may be applied to the film. The application of a vacuum may flatten the film against the surface. The assembly may also comprise a base comprising a cavity configured to receive and support a tray, and at least two receptacles configured to receive at least two pegs of the lid. The film may comprise a molecular array which may be immobilized on one side of the film.

### RELATED APPLICATIONS

This application claims the benefit of priority under 35 U.S.C. § 119 (e) to U.S. Provisional Application Ser. No. 63/301,451, filed Jan. 20, 2022, which is incorporated herein by reference in its entirety.

### FIELD

Disclosed embodiments are related to devices, assemblies, and systems for handling a film, placing a film, positioning a film, and securing a film on an object and related methods of use of said devices.

### BACKGROUND

In the biotechnology and pharmaceutical sector, large scale studies are conventionally performed in homogeneous assays on a well plate or tray such as a microtiter plate (e.g., 96 well and 384 well plates are common and higher capacity plates are available) or in an array format. Assay materials may be disposed in individual wells of a tray and may be employed to detect the presence of a nucleotide sequence (e.g., a marker) or other biological materials. Typically, assay materials are manually placed in a tray (e.g., in a well) during a testing process. Accurate placement and indexing of an assay material and a biological sample is important to provide accurate test results.

### SUMMARY

In some embodiments, a device comprises a body comprising a surface configured to receive a film, one or more alignment protrusions disposed on at least one border of the surface, where the one or more alignment protrusions extend past the surface, a pressure chamber disposed in the body, and a plurality of vent openings formed in the surface, where the plurality of vent openings is in pneumatic connection with the pressure chamber, and where the vent openings of the plurality of vent openings are configured to apply a negative pressure to the surface to flatten the film against the surface as the negative pressure is provided to the pressure chamber.

In some embodiments, a device comprises a film comprising a molecular array disposed on a first side of the film, a body comprising a surface, where a second side of the film is disposed on the surface, a pressure chamber disposed in the body, and a plurality of vent openings formed in the surface, where the plurality of vent openings is in pneumatic connection with the pressure chamber, and where the vent openings of the plurality of vent openings are configured to apply a negative pressure to the surface to flatten the film against the surface as the negative pressure is provided to the pressure chamber.

In some embodiments, an assembly for securing a film to a tray comprises a lid and a base. The lid comprises a body comprising a surface configured to receive the film, a pressure chamber disposed in the body, a plurality of vent openings formed in the surface, where the plurality of vent openings is in pneumatic connection with the pressure chamber, and at least two pegs extending from the body in a direction perpendicular from the surface. The base comprises a cavity configured to receive and support the tray, and at least two receptacles configured to receive the at least two pegs of the lid.

In some embodiments, a method of securing a film to an object comprises placing a first side of the film on a surface of a body, where the film comprises a molecular array disposed on a second side of the film, and flattening the film against the surface by applying a vacuum to the surface via a plurality of vent openings formed in the surface.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a perspective view of one embodiment of an assembly for securing a film to an object;

FIG. 2 is a perspective view of a lid of the assembly of FIG. 1;

FIG. 3 is a plan view of the lid of FIG. 2;

FIG. 4A depicts the lid of FIG. 3 and one embodiment of a film in a first state;

FIG. 4B depicts the lid and film of FIG. 4A in a second state;

FIG. 5A depicts a side view of the lid of FIG. 2 and another embodiment of a film in a first state;

FIG. 5B depicts the lid and film of FIG. 5A in a second state;

FIG. 6 is a side schematic of an enlarged view of a top portion of one embodiment of a film receiving surface of a lid;

FIG. 7 is a flow chart for one embodiment of a method of securing a film to an object;

FIG. 8A depicts a schematic of one embodiment of a lid in a first state;

FIG. 8B depicts a schematic of the lid of FIG. 8A in a second state;

FIG. 8C depicts a schematic of the lid of FIG. 8A in a third state;

FIG. 8D depicts a schematic of the lid of FIG. 8A in a fourth state;

FIG. 8E depicts a schematic of the lid of FIG. 8A in a fifth state;

FIG. 8F depicts a schematic of the lid of FIG. 8A in a sixth state;

FIG. 9 is a flow chart for another embodiment of a method of securing a film to an object;

FIG. 10 is a perspective view of a base of the assembly of FIG. 1;

FIG. 11 is a perspective view of the base of FIG. 10 and one embodiment of a tray;

FIG. 12A is a cross-sectional view of the base of FIG. 11 taken along line 12A-12A;

FIG. 12B is a cross-sectional view of the base of FIG. 11 taken along line 12B-12B;

FIG. 13 is a side schematic of an embodiment of an assembly for securing a film to an object;

FIG. 14A depicts an enlarged view of section 14 of the assembly of FIG. 13 in a first state;

FIG. 14B depicts an enlarged view of section 14 of the assembly of FIG. 13 in a second state;

FIG. 14C depicts an enlarged view of section 14 of the assembly of FIG. 13 in a third state;

FIG. 14D depicts an enlarged view of section 14 of the assembly of FIG. 13 in a fourth state;

FIG. 15A depicts a schematic of one embodiment of an assembly for securing a film to an object in a first state;

FIG. 15B depicts a schematic of the assembly of FIG. 15A in a second state;

FIG. 15C depicts a schematic of the lid of FIG. 15A in a third state;

FIG. 15D depicts a schematic of the lid of FIG. 15A in a fourth state;

FIG. 15E depicts a schematic of the lid of FIG. 15A in a fifth state;

FIG. 15F depicts a schematic of the lid of FIG. 15A in a sixth state;

FIG. 16 is a flow chart for another embodiment of a method of securing a film to an object;

FIG. 17 is a side schematic of another embodiment of an assembly for securing a film to an object;

FIG. 18 is a side schematic of another embodiment of an assembly for securing a film to an object; and

FIG. 19 is a schematic of an embodiment of an automated system for securing a film to an object.

### DETAILED DESCRIPTION

Devices, assemblies and methods are disclosed herein that solve certain problems related to the manufacture of certain novel multi-well plates, and which provide for high throughput automated manufacturing of said plates. The novel multi-well plates disclosed herein often comprise an ultra-thin film (e.g., substrate) and a tray that is attached to the film, where the tray provides the vertical interior sides of each well, and the ultra-thin film defines a bottom portion of substantially all wells of each plate. The bottom portion of each well often comprises a molecular array disposed on the ultra-thin film. In certain embodiments, the manufacturing process of the novel multi-well plates disclosed herein requires automated printing of multiple molecular arrays on each ultra-thin film substrate prior to attaching a film to a tray. Each molecular array is often printed in a pre-defined, spatially addressable location on one side of a film. Therefore the manufacturing process of a plate disclosed herein requires precise positioning and alignment of a pre-printed film with a tray while attaching a film to a tray.

In some embodiments, the ultra-thin films disclosed herein are designed for an assay that requires high-resolution digital imaging such that molecules attached to the bottom portion of each well (i.e., the film) are individually optically resolvable (e.g., see WO/2016/134191). Accordingly, the ultra-thin films used for the novel multi-well plates disclosed herein require certain optical properties, and said films are often fragile and are susceptible to warping, flexing, deformation and/or breaking. Further, a molecular array disposed on a film is often susceptible to contamination or destruction when handled. Therefore the manufacturing process of each plate requires delicate handling of an ultra-thin film while placing, positioning and/or attaching the ultra-thin film to an object (e.g., a tray). In some embodiments, the devices, assemblies and methods disclosed herein provide for robotic automation of said handling, placement, positioning and attachment of a film.

In view of the above, the inventors have appreciated the numerous benefits of an assembly configured to secure a film to an object (e.g., a tray). The assembly may allow for repeatable, accurate alignment between the film and the object. An assembly may also allow for handling of a film in a manner that does not disturb or contaminate any molecules or molecular arrays attached to, or disposed on, a film. Finally, the assembly may ensure that a film is reliably positioned relative to an object and is formed into an appropriate geometry for securement to the object. For example, assemblies according to exemplary embodiments described herein may be configured to flatten a film for placement on the object, such that the film may be secured in a flattened state.

In some embodiments, an assembly for securing a film to an object comprises a lid and a base. A lid may comprise a surface configured to receive a film. A surface may comprise a plurality of vent openings (e.g., holes, grooves, channels, etc.) that are configured to apply a positive pressure or negative pressure (e.g., a vacuum) to the surface. In some embodiments, a plurality of vent openings may be operably connected (e.g., pneumatically connected) to a pressure source (e.g., via a pressure chamber). In some embodiments, a pressure source is configured to provide a positive pressure or a negative pressure (e.g., a vacuum). A plurality of vent openings may be configured to apply a negative pressure (e.g., a vacuum) from a pressure source to a surface to secure a film to the surface. A plurality of vent openings may be configured to apply positive pressure to a surface to separate, disengage, eject and/or lift the film from the surface. In some embodiments a lid comprises one or more pegs (e.g., round pegs, square pegs, etc.) that extend from the lid. A base of the assembly may comprise a cavity configured to receive and retain an object, such as a tray. A base may comprise a plurality of receptacles (e.g., at least two receptacles) that are each configured to receive a corresponding peg of a lid. Receptacles may be positioned relative to the cavity such that the receptacles position a lid relative to the cavity when the receptacles receive the pegs of the lid. Accordingly, pegs and receptacles may reliably position a lid relative to a base when the base receives the lid. Correspondingly, a film disposed on the surface of the lid and an object disposed in the cavity of the base may also be aligned with one another. In some embodiments, a lid may be employed to press a film onto an object disposed in the cavity while pegs of the lid are received in receptacles of a base. In some embodiments, a plurality of vent openings may apply a positive pressure (e.g., via a pressure source) to eject the film from the surface, thereby forcing the film against the object. This force may be employed to secure the film to the object. In some embodiments, an intermediary material such an adhesive may permanently bond a film to an object under force from positive pressure.

According to exemplary embodiments described herein, a lid may comprise at least two pegs and a base may comprise at least two receptacles. However, in other embodiments, a receptacle may comprise at least two pegs and a lid may comprise at least two receptacles. In still other embodiments, a lid may comprise a peg and a receptacle, and a base may comprise a corresponding receptacle and a peg. Accordingly, pairs of pegs and receptacles may be disposed in any combination on a lid and a base, as the present disclosure is not so limited. A peg may be a protrusion having any suitable shape. For example, a peg may be square, rectangular, circular, ellipsoidal, polygonal, or any other suitable shape. A receptacle may have any suitable shape configured to receive a corresponding peg. For example, a receptacle may be square, rectangular, circular, ellipsoidal, polygonal, or any other suitable shape. A peg and a receptacle may also have any suitable dimensions, as the present disclosure is not so limited. In some embodiments, a receptacle may be configured to constrain movement of a peg within the receptacle to one or more directions. For example, a receptacle may be helical and constrain a peg to translate in one direction while rotating in another direction (for a total of two directions of motion). Such an arrangement may allow a lid to rotate around an obstacle, for example. In some embodiments, a receptacle may be configured to constrain movement of a peg to a single axis when the peg is received in the receptacle. For example, a peg may be configured to slide within a receptacle in a single direction. Of course, a receptacle may be configured to constrain the motion of a peg within any suitable number of directions, as the present disclosure is not so limited. In some embodiments, the shape of the receptacle may correspond to the shape of the peg. In some embodiments, a peg and/or a receptacle may comprise a lead-in. For example, in some embodiments a peg may comprise a taper at a distal end of the peg that first is received in a receptacle. As an alternative example, in some embodiments, a receptacle may comprise chamfering. As still yet another example, in some embodiments, a peg may comprise a taper, and a receptacle may comprise corresponding chamfering. In such embodiments, the lead-in of the peg and/or receptacle may urge the peg into alignment with the receptacle so as to simplify insertion of the peg into the receptacle. Of course, in some embodiments, no lead-in may be employed on a peg and/or receptacle, as the present disclosure is not so limited.

According to exemplary embodiments described herein, at least two receptacles and at least two corresponding pegs may constrain a lid and a receptacle to move relative to one another along a single axis (e.g., an axis parallel to an insertion direction for the at least two pegs). For example, when at least two pegs are disposed in at least two receptacles, a lid may not be able to move (e.g., rotate, move transversely, etc.) relative to the base except in a direction moving the at least two pegs further into the at least two receptacles or out of the at least two receptacles. Of course, while certain numbers of pegs and receptacles are shown and described with reference to exemplary embodiments described herein, any suitable number of pegs and receptacles may be employed, including, but not limited to, 2 pairs pegs and receptacle, 3 pairs pegs and receptacles, 4 pairs of pegs and receptacles, 5 pairs of pegs and receptacles, or any other suitable number of pairs.

According to exemplary embodiments described herein, a lid and base may comprise one or more peg and receptacle pairs that are configured to align the lid with the base. However, in other embodiments a lid and base may not include pegs, receptacles, or any other structures configured to align the lid and the base. In some such embodiments, a lid and a base may be aligned with one another by an automated system. In some embodiments, an automated system may comprise one or more grippers configured to place objects (e.g., lid, film, base, object such as a tray, etc.) relative to one another. In some embodiments, the one or more grippers may be configured to align a lid with a base without the use of pegs and receptacles. The automated system may control the one or more grippers (e.g., with one or more processors) to ensure the lid is appropriately aligned with the base. For example, one or more grippers may include stepper motors, servomotors, or other motors which allow for precise control of the one or more grippers so that the relative position and alignment of the lid and base may be controlled by the automated system.

In some embodiments, a method of securing a film to an object (e.g., a tray) comprises placing a film on a surface of a lid and applying a vacuum to the surface via a plurality of vent openings. For example, in some embodiments, a vacuum may be applied by a pressure source. In some embodiments, applying the vacuum to the surface may flatten the film against the surface, such that the film at least partially takes the shape of the surface. In some embodiments, a surface may be substantially flat, such that the film is correspondingly made substantially flat. In some embodiments, “substantially flat” may correspond to a flatness tolerance within 100 microns. In some embodiments, the surface may be profiled to match a shape of the film such as, for example, when the film is warped or there is an indication that the film holds one or more stresses that could cause warpage in the future. In these embodiments, a profile (e.g., a crown, a dip) is added to the surface to match the film within a tolerance (e.g., 100 microns). The method may also comprise inserting at least two pegs into at least two receptacles of a base. Inserting the at least two pegs into the at least two receptacles may comprise aligning the lid with the base, and correspondingly aligning the film with the object. In some embodiments, inserting at least two pegs into at least two receptacles may comprise inverting a lid. In other embodiments, inserting at least two pegs into at least two receptacles may comprise inverting a base. The base may comprise the object that is secured in a cavity. In some embodiments, the method may comprise moving a lid toward a base until a film is in contact with an object while at least two pegs are received in at least two receptacles. The method may also comprise applying a positive pressure to a surface via a plurality of vent openings to force a film against an object and to eject the film from the surface. In some embodiments, the method may comprise bonding a film to an object with an adhesive.

According to exemplary embodiments described herein, a lid may comprise a plurality of vent openings formed in a surface configured to receive a film. In some embodiments, a plurality of vent openings may be arranged in an array across a surface of a lid. Such embodiments may distribute pressure applied to a film across a surface area of the film. In some embodiments, a film may be configured to be secured to a tray such as a well plate, as discussed above. A well plate may comprise a plurality of wells arranged in a plurality of rows and columns. In some embodiments, a plurality of vent openings may be arranged in an array corresponding to a plurality of rows and columns. That is, the plurality of vent openings may be configured in rows and columns to be aligned with walls of a well plate. According to such embodiments, application of positive pressure from a plurality of vent openings may be focused on portions of a film aligned with the walls of the well plate. Accordingly, decreased deformation may be applied to unsupported regions of a film as the film is secured to a well plate compared with supported regions of the film. Of course, in other embodiments a plurality of vent openings may be arranged in any suitable pattern or spacing, as the present disclosure is not so limited.

In addition to the above, the inventors have appreciated the benefits of a device configured to form a film into a desired shape before the film is applied to an object such as a tray. In some cases, a film may be a thin rigid material that may be susceptible to warping or other non-uniform characteristics as a result of manufacturing tolerances, handling, or other events. If a film is not deformed elastically or plastically to a desired shape, the film may have uneven adherence to an object, and/or portions of the film may be misaligned with the object. Accordingly, devices and assemblies according to exemplary embodiments described herein may be configured to flatten a film before the film is secured to an object, such that consistent, repeatable securement of films to objects is provided.

In some embodiments, a device comprises a body (e.g., a chassis) having a surface configured to receive a film. In some embodiments as discussed previously, a film may comprise a plurality of molecular arrays (e.g., capture probes) disposed on one side of the film. The surface may comprise a plurality of vent openings formed in the surface that are operably connected (e.g., pneumatically connected) to a pressure source (e.g., via a pressure chamber). The pressure source may be configured to apply a positive pressure or negative pressure (e.g., a vacuum) to a film received on the surface via the plurality of vent openings. When a negative pressure is applied to the film, such application of negative pressure may force the film into further engagement with the surface. Accordingly, if the film is warped or otherwise not flush with the surface, the film may be deformed to be flush with the surface. As a result, the film may adopt the surface profile of the surface. In some embodiments, a surface profile of a surface may be substantially flat. For example, in some embodiments, a substantially flat surface may have a flatness tolerance within 100 microns, 75 microns, 50 microns, 25 microns, 10 microns, or 5 microns. According to this example, while negative pressure is applied via a plurality of vent openings, a film may approach if not match the flatness of the surface. In some embodiments as will be discussed further herein, a film may be secured to an object while a negative pressure is applied, such that the film permanently retains the profile of the surface once secured to the object. Thus, the device may be used with a plurality of films having variations in shape or flatness while still achieving a consistent object and film final product. While exemplary embodiments described herein have a planar surface against which a film is flattened, a surface may have any suitable shape, including concave or convex shapes, as the present disclosure is not so limited.

In some embodiments, a method of securing a film to an object comprises placing a film on a surface of a body. A surface may comprise a plurality of vent openings formed in the surface through which positive or negative pressure may be applied to a side of the film in contact with the surface. The method may also comprise flattening a film against a surface by applying negative pressure (e.g., a vacuum) to the film via a plurality of vent openings. In some embodiments, flattening a film against the surface may comprise making a film substantially planar. The method may also comprise placing a film in contact with an object such as a tray while negative pressure is applied to the film. The method may also comprise bonding a film to an object to secure the film to the object in a flattened condition. For example, in some embodiments an adhesive may permanently bond the film to the tray with the film in the flattened condition. In some embodiments, the method may be repeated for multiple films having different shapes and/or warpage, where each secured film has approximately the same shape due to the flattening process. In some embodiments, a surface may be nonplanar such that a film is formed into the shape of the nonplanar surface.

In addition to the above, the inventors have appreciated the benefits of a device configured to repeatably align a film so that the film may be repeatably secured to an object. In some embodiments, a film may be a thin material that is fragile, sterile, or otherwise difficult to handle manually or with automated systems. Accordingly, the inventors have appreciated a device and method configured to allow for alignment of a film to a known position on the device without physical manipulation of the film that may result in damage and/or contamination in some instances.

In some embodiments, a device for securing a film to an object comprises a body (e.g., chassis, frame, etc.) comprising a surface configured to receive a film. In some embodiments a device comprises a body comprising a surface configured to receive a film. In some embodiments, the device may comprise alignment protrusions disposed on at least one border of the surface. In some embodiments, a body or surface of a device comprises 2 or more, 4 or more or 6 or more alignment protrusions. In some embodiments, a body or surface of a device comprises 2 to 10, 2 to 5 or 2 to 4 alignment protrusions. In some embodiments, one or more borders disposed on a surface define a predetermined position for alignment of a film when engaged with the surface of the device. In some embodiments, one or more alignment protrusions are disposed on the one or more borders. In some embodiments one or more alignment protrusions are configured to position and/or align a film on a surface, often in preparation of transferring, contacting and/or positioning a film on an object or a tray. Thus, the alignment protrusions are configured to make contact with one or more edges of the film when contacted with the surface of the device and the alignment protrusions may extend past the surface (e.g., in a direction distal to the surface, transverse to the surface, and/or perpendicular to the surface), such that an edge of a film disposed on the surface may contact the alignment protrusions. In some embodiments an alignment protrusion extends from 0.001 to 10 mm, 0.01 to 5 mm, 0.01 to 1 mm, 0.01 to 0.5 mm, or intermediate ranges thereof, past (e.g., distal to, e.g., above) a plane of a surface. In some embodiments, one or more alignment protrusions may extend a distance past a surface (e.g., in a direction perpendicular to a plane of the surface) that is greater than or equal to 25% of a thickness of a film, 50% of a thickness of a film, 75% of a thickness of a film, 100% of a thickness of a film, 150% of a thickness of a film, and/or another other appropriate percentage of film thickness. In some embodiments, the alignment protrusions may extend perpendicular to the surface, though other directions of extension are contemplated. The surface may be configured such that the film may slide along the surface into engagement with the alignment protrusions. When a film abuts alignment protrusions, the position of the film may be known relative to the abutted alignment protrusions. For example, where the alignment protrusions are disposed on one border of the surface, a film abutting those alignment protrusions is aligned with the one border. In another example, where the alignment protrusions are disposed on two borders, a film abutting the alignment protrusions is aligned with the two borders. In this manner, the film may be aligned with known positions on the device, such that the film may be positioned accurately on an object such as a tray. In some embodiments, alignment protrusions may be disposed on a first border and a second border, where the first border and second border are transverse to one another. According to such an embodiment, the first border and second border may define a corner of the surface. Movement of a film into abutment with the alignment protrusions may comprise moving the film in two planar directions (e.g., x-direction and y-direction) along the surface. Accordingly, when a film is in abutment with the alignment protrusions, a position of the film in an x-y plane may be known relative to a device. In some embodiments, a first border and second border may be perpendicular to one another. For example, in some embodiments, a surface may be rectangular, comprising four borders perpendicular to one another. An alignment protrusion may have any suitable shape, such as round pins, rectangular pins or walls, etc., or a combination thereof.

While in some embodiments, a device for securing a film to an object comprises alignment protrusions disposed on a first border and second border of a surface that are transverse to one another, in other embodiments a surface may have a continuous border without discontinuities. In some such embodiments, a first border and a second border may be continuous, such that the surface has no distinct corners. For example, in some embodiments, the surface may be circular, ellipsoidal, stadium-shaped, or another round shape. In some such embodiments, the first border and second border may form separate portions of the continuous shape of the surface, such alignment protrusions disposed on the border may restrict movement of an abutting film in two directions. For example, a first border may form a first quadrant of a circular border, and a second border may form a second quadrant of a circular border. In some embodiments, the two directions in which the alignment protrusions restrict movement are non-parallel. In some embodiments, the two directions may be approximately perpendicular to one another (e.g., perpendicular). Of course, alignment protrusions may be disposed in any suitable shape, as the present disclosure is not so limited.

According to exemplary embodiments described herein, one or more alignment protrusions may extend past a surface of a device in a direction distal to the surface. For example, in some embodiments, an alignment protrusion may extend in a direction transverse (e.g., perpendicular) to a surface. In some embodiments, an alignment protrusion may extend past a surface of a device to an extent such that at least a portion of an edge of a film may abut the alignment protrusion. In some embodiments, one or more alignment protrusions may extend a distance past a surface (e.g., in a direction perpendicular to a plane of the surface) that is greater than or equal to 25% of a thickness of a film, 50% of a thickness of a film, 75% of a thickness of a film, 100% of a thickness of a film, 150% of a thickness of a film, and/or another other appropriate percentage of film thickness.

In some embodiments, a device for securing a film to an object comprising alignment protrusions comprises a plurality of vent openings formed in a surface configured to receive the film. As discussed previously in reference to other embodiments, a plurality of vent openings may be configured to apply positive or negative pressure to a film disposed on the surface or cause a positive or negative pressure to be applied to the film disposed on the surface. In some embodiments, the positive or negative pressure is applied through the vent openings by a pressure source, such as a pump, a vacuum, etc. In some embodiments, the positive and negative pressure may be employed to assist in aligning a film placed on the surface with a known position. For example, in some embodiments, a positive pressure may be applied to a film disposed on a surface to lift the film on the surface. While positive pressure is applied, the film may stay at least partially out of contact with the surface disposed on an air cushion above the surface. Accordingly, the device may be inclined such that the film slides on the air cushion into contact with one or more alignment protrusions. Such an arrangement may negate or reduce friction between a surface and a film and/or adhesion between the film and the surface due to static cling. Once a film is abutting one or more alignment protrusions, negative pressure may be applied to the film to secure the film to the surface in the known position. Once in the known position, the device may be employed to place the film in contact with an object and secure the film to an object. Of course, in some embodiments, a film may be configured to slide on a surface, as the present disclosure is not so limited. In some such embodiments, the surface may be formed of a low-friction material such as polytetrafluoroethylene (PTFE), nylon, acetal, metal, glass, aluminum, or another polymer. In one embodiment, when the surface is made of aluminum, the surface could be anodized with a PTFE hard coat or coated with tungsten disulfide.

According to exemplary embodiments described herein, a film may comprise one or more molecular arrays or molecules disposed on a side of the film. For example, a film may comprise a plurality of capture probes such as oligonucleotides. In some embodiments the capture probes may be immobilized (e.g., in the solid phase). In some embodiments, a molecular array may be configured to detect a genetic variation in a genetic sample from a subject using labeled probes and counting the number of labels in the probes. In some embodiments, a molecular array may be a spatially addressable molecular array and may enable analytical approaches based on single molecule detection techniques. In some embodiments, a molecular array may comprise between 500 and 1000 individual capture probes. In some embodiments, a film comprising a molecular array may be formed by printing capture probes onto one side of the film (e.g., using one or more nozzles). Due to the number of individual spots when printing such a film, the inventors have appreciated the benefits of preparing a film separately from an object onto which the film is mounted (e.g., a tray). Accordingly, once a film is prepared comprising one or more molecular arrays, it may be secured to an object. In some cases, a tolerance for misalignment between a film and an object is less than 150 microns, 100 microns, or 50 microns.

In some embodiments, a film may be a solid substrate. The substrate can be porous to allow immobilization of molecules within the substrate or substantially non-porous, in which case molecules may be immobilized on a surface of the substrate. The film described herein can be made of any material to which molecules can be bound, either directly or indirectly. Examples of suitable film materials include flat glass, quartz, silicon wafers, mica, ceramics, metals, compound materials, and organic polymers such as plastics, including polystyrene and polymethacrylate. Compound materials can include tapes, thermal films, foil, etc. In some embodiments, the film can be made of multiple materials. For example, a film that is a thermally laminated foil may comprise a plurality of layers, including metals (e.g., aluminum) and plastics (e.g., polyethylene, polypropylene). In some embodiments, a surface of the film can be configured to act as an electrode or a thermally conductive substrate, which may enhance a hybridization or discrimination process. For example, in some embodiments, micro and sub-micro electrodes can be formed on a surface of a film using lithographic techniques. In some embodiments, nanoelectrodes can be made by electron beam writing/lithography. In some embodiments, electrodes can also be made using conducting polymers which can pattern a film by ink-jet printing devices, by soft lithography or be applied homogeneously by wet chemistry. In some embodiments, a film may be a TnO2 coated glass substrate. Electrodes can be provided at a density such that each immobilized molecule has its own electrode or at a higher density such that groups of molecules (e.g., a molecular array) are connected to an individual electrode.

It should be noted that while some exemplary embodiments described herein relate to films often comprising biological molecular arrays, the present disclosure is not so limited, in this regard. Assemblies and methods according to exemplary embodiments described herein may be employed with a film that does not comprise biological molecular arrays. That is, the assemblies described herein provide the ability to simply and repeatably secure a film to an object. Accordingly, films may comprise one or more molecular arrays or may not comprise any molecular array, as the present disclosure is not so limited.

In some embodiments a film comprises a relatively thin, optically transparent substrate that is substantially flat or planar, and/or capable of being substantially flat or planar. In some embodiments, a film is a substantially rigid substrate and comprises a material such as glass or a rigid plastic that does not undergo significant plastic deformation. In some embodiments, a film is somewhat pliable or elastic and may deform, such that the film may be flattened against a surface of a device as described herein. A film may comprise any suitable optically transparent material. In some embodiments a film comprises glass, silica borosilicate, quartz, polycarbonate plastic, the like and combinations thereof. In some embodiments a film comprises a refractive index of less than 1.5, less than 1.3, less than 1.1 or less than 1 for light having a wavelength in the range of 360-820 nm. In some embodiments a film comprises a refractive index of 1.0000 to 1.5000, 1.0000 to 1.3000, 1.0000 to 1.1000, 1.0000 to 1.0500, 1.0000 to 1.0100, 1.0000 to 1.0050, 1.0000 to 1.0005 for light having a wavelength in the range of 360-820 nm. In some embodiments, a film provides for an absorbance of light having a wavelength in the range of 180-780 nm of 0.2 absorbance units (Au) or less, 0.1 Au or less or 0.05 Au or less. In some embodiments, a film provides for an absorbance of light having a wavelength in the range of 360-820 nm of 0.2 absorbance units (Au) or less, 0.1 Au or less or 0.05 Au or less. In some embodiments, a film provides for an absorbance of light having a wavelength in the range of 180-780 nm of 0.20 to 0.000001 Au, 0.10 to 0.000001 Au, 0.05 to 0.000001 Au, 0.005 to 0.000001 Au, 0.0005 to 0.000001 Au. In some embodiments, a film provides for an absorbance of light having a wavelength in the range of 360-820 nm of 0.20 to 0.000001 Au, 0.10 to 0.000001 Au, 0.05 to 0.000001 Au, 0.005 to 0.000001 Au, 0.0005 to 0.000001 Au. In some embodiments, a film has a thickness less than or equal to 500 microns, 400 microns, 300 microns, 200 microns, 100 microns, or 50 microns. In some embodiments, a film has a thickness in a range of 200 to 10 microns, 100 to 10 microns, 75 to 10 microns or 60 to 20 microns. In some embodiments, a film has a surface area in a range of 1 to 3000 cm², 1 to 1000 cm², 10 to 1000 cm², 10 to 500 cm². 25 to 500 cm², or intermediate ranges thereof. Of course, a film may be formed of any suitable material of any suitable thickness, as the present disclosure is not so limited.

In some embodiments, a surface of a device configured to receive a film may have a flatness tolerance less than or equal to 100 microns, 75 microns, 50 microns, 25 microns, 10 microns, or 5 microns. In some embodiments, a surface of a device has a flatness tolerance in range of 5 to 50 microns, 25 to 100 microns, or 25 to 75 microns. In some embodiments, a film may have a flatness tolerance less than or equal to 200 microns, 150 microns, 100 microns, 80 microns, or 50 microns. In some embodiments, a film may have a flatness tolerance in a range of 50 to 150 microns, 50 to 100 microns, or 50 to 200 microns. In some embodiments, a film may have a flatness tolerance that is greater than a flatness tolerance of a surface of a device for securing the film to an object. For example, in some embodiments, a film may have a flatness tolerance between 50 and 150 microns, that may be greater than a flatness tolerance of the surface of the device between 5 and 50 microns. In some embodiments, when a film is flattened against a surface of a device, the flatness tolerance of the film may approximately match that of the surface. For example, a film having a flatness tolerance between 50 and 150 microns may have a flatness tolerance between 5 and 50 microns when flattened against a surface.

In some embodiments, a film may have a Young's Modulus (e.g., modulus of elasticity) in a range of 100 to 0.002 Gigapascals (GPa), 100 to 10 GPa, 80 to 10 GPa, 40 to 0.002 GPa, 40 to 0.1 GPa, 10 to 0.002 GPa, 5 to 0.02 GPa, or intermediate ranges thereof. In some embodiments, a film may have a fracture toughness measured with a load of 20 newtons (N) in a range of 2.5 to 0.2 MPa M^{1/2}, 1.5 to 0.5 MPa M^{1/2}, 1.0 to 0.5 MPa M^{1/2}, or intermediate ranges thereof. According to exemplary embodiments described herein, adhesives may be employed to secure a film to an object such as a tray. In some cases, adhesives may bond a film to an object on contact. In other embodiments, an adhesive may be cured via input of energy such as light (e.g., UV light) and/or heat. In some embodiments, a device for securing a film to an object may be configured to cure an adhesive bonding the film to the object. For example, in some embodiments a device may comprise a surface that is at least partially transparent to ultraviolet light. The device may comprise one or more ultraviolet light sources (e.g., LEDs) configured to emit ultraviolet light through at least partially transparent surface or portions thereof. Accordingly, ultraviolet light may strike a film disposed on the surface of the device. In embodiments where a film is transparent, ultraviolet light may pass through the film and encounter an adhesive disposed between the film and an object. In this manner, the device may cure the adhesive. Such an arrangement may also allow the device to retain a shape of the film against the surface while the adhesive is cured. Once cured, the adhesive and object may retain the shape of the film. As another example, in some embodiments, a device may comprise one or more heating elements (e.g., resistive heating elements, thermo electric heat pump, Peltier cooler) disposed in a surface. The one or more heating elements may be configured to heat the surface, which may in turn heat a film disposed on the surface. The heated film may warm an adhesive between the film and the object, thereby heat curing the adhesive. Of course, any suitable adhesive or fastener may be employed to secure a film to an object, including adhesives not requiring input of light or heat for curing, as the present disclosure is not so limited.

As used herein, an object may be any three-dimensional structure configured to receive a film. An object may comprise a film receiving surface configured to receive a film. In some embodiments, the film receiving surface may be substantially flat (e.g., may have a flatness tolerance between 5 and 50 microns). In some embodiments, the object may be a tray. A tray may comprise one or more walls. A tray may comprise at least one volume defined by the base and the one or more walls. In some embodiments, a tray may be a well plate. A well plate may comprise a plurality of walls and volumes defined by the plurality of walls. In some embodiments, a well plate may comprise a plurality of walls arranged in an array of rows and columns. In some embodiments, a well plate may comprise 2 or more, 4 or more 10 or more or 50 or more wells (e.g., volumes). In some embodiments, a well plate may comprise 96 volumes or 384 volumes, though any number of volumes may be included as a part of a well plate, as the present disclosure is not so limited.

In some embodiments, an assembly or base (e.g., base 150) is configured to receive a tray. A tray often comprises a plurality of vertical walls (e.g., see FIG. 11, 254) that form the wells (e.g., see FIG. 11, 252) of a multi-well plate after attachment of a film that forms the bottom portion or base of each well. Accordingly, the vertical walls of a tray may have any suitable dimensions such that the vertical walls of the tray define a plurality of spaces that later, after attachment of a film, form a plurality of wells, each configured to hold a volume of a liquid. In some embodiments a tray comprises a top side and a bottom side, where the vertical walls of a tray extend from the top side to the bottom side of the tray. The verticals walls of a tray often terminate at the bottom side of a tray thereby defining a plane that is often substantially perpendicular to the vertical walls of the tray. Accordingly, each of the vertical walls of a tray often comprise a bottom edge that is located within the same plane at the bottom of a tray and the bottom edges of each of the vertical walls therefore provide a film receiving surface configured to attach to a substantially planar film (e.g., a film flattened on a surface of a lid).

Assemblies according to exemplary embodiments described herein may be operated by a human user or by an automated system. Correspondingly, methods according to exemplary embodiments herein may be performed by a human user or by an automated system. In some embodiments, an automated system may be configured to prepare an object and film combination such as a well plate comprising a molecular array. In some embodiments, an automated system may comprise one or more grippers configured to place objects (e.g., lid, film, base, object such as a tray, etc.) relative to one another. An automated system may be configured to couple a lid to a base, such that a film disposed on the lid may be brought into engagement with an object disposed in the base. An automated system may also be configured to operate a pressure source to apply positive or negative pressure to the film disposed on the lid. In some embodiments, an automated system may comprise one or more imaging sensors configured to provide feedback regarding an assembly process. For example, the one or more imaging sensors may provide information to a processor so that the processor may determine if a film is secured in an appropriate location on a lid, if a lid is properly coupled to a base, and if a film is appropriately secured to an object. Accordingly, an automated system may prepare an object and film combination in an automated manner.

According to exemplary embodiments described herein, an automated system may be operated by one or more processors. The one or more processors may be configured to execute computer readable instructions stored in volatile or non-volatile memory. The one or more processors may communicate with one or more actuators associated with various elements of the automated system (e.g., grippers, pressure source, etc.) to control movement or operation of the various elements. The one or more processors may receive information from one or more sensors that provide feedback regarding the various elements of the automated system. For example, the one or more processors may receive position information regarding a gripper. In this manner, the processor may implement proportional control, integral control, derivative control, or a combination thereof (e.g., PID control). Other feedback control schemes are also contemplated, and the present disclosure is not limited in this regard. Any suitable sensors in any desirable quantities may be employed to provide feedback information to the one or more processors. Accelerometers, rotary encoders, potentiometers, imaging sensors (e.g., cameras), and height sensors may be employed in coordination with desirable processing techniques (e.g., machine vision). The one or more processors may also communicate with other controllers, computers, and/or processors on a local area network, wide area network, or internet using an appropriate wireless or wired communication protocol. In some embodiments, a processor may execute computer readable instructions based at least in part on input from a user. For example, a processor may receive input comprising a series of actions to be executed by the automated system. The one or more processors may execute the instructions based at least partly on the input to secure a film to an object. It should be noted that while exemplary embodiments described herein are described with reference to a single processor, any suitable number of processors may be employed as a part of an automated system, as the present disclosure is not so limited.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

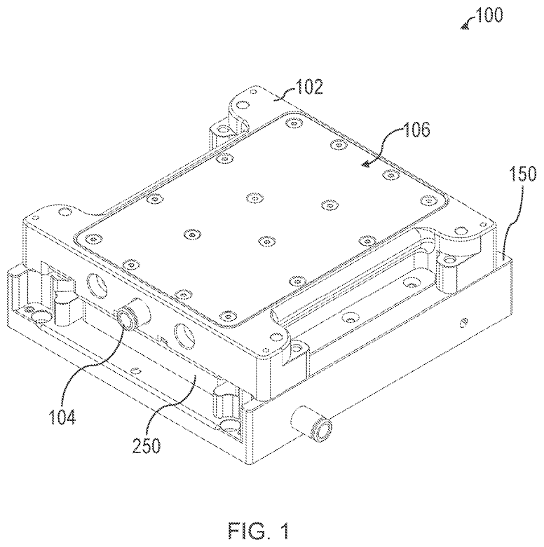

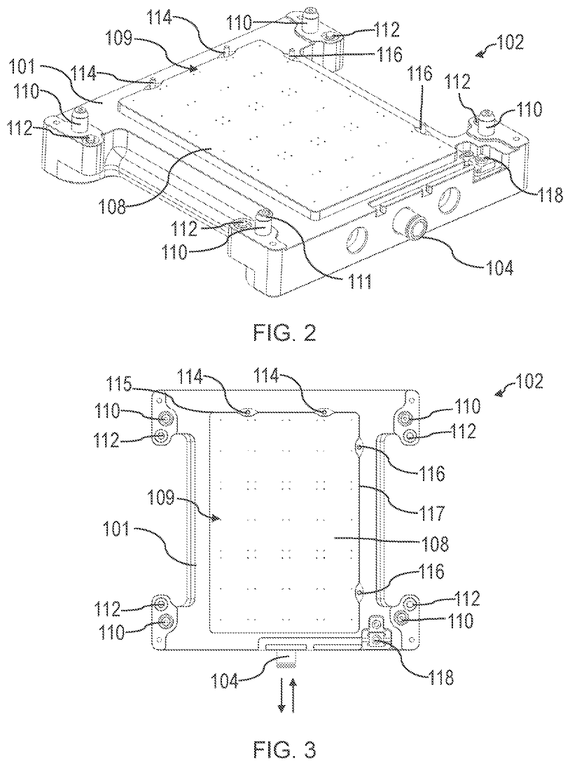

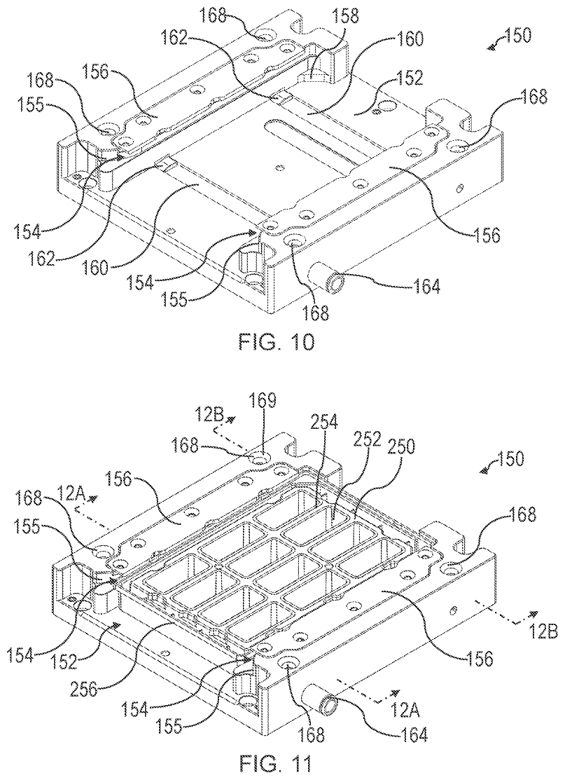

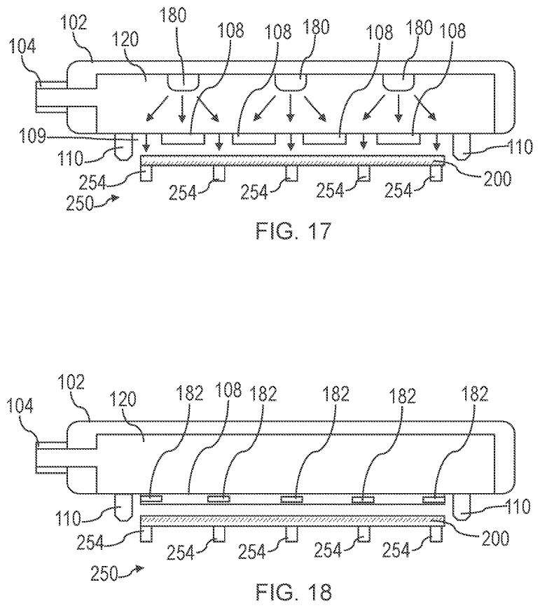

FIG. 1 is a top perspective view of one embodiment of an assembly 100 for securing a film to an object. As shown in FIG. 1, the assembly comprises a lid 102 and a base 150, each of which will be discussed in further detail below. In some embodiments, the lid 102 comprises a chamber plate 106 that encloses a pressure chamber 120 (e.g., see 120 in FIGS. 17 and 18). As shown in FIG. 1, the lid comprises a pressure connection 104 (e.g., a fitting) that is in pneumatic communication with the pressure chamber 120. In some embodiments, a chamber plate 106 is removable. Air (or another gas) is able to flow from the pressure connection 104 to the internal pressure chamber (e.g., 120). The pressure connection 104 may be configured to pneumatically connect to a pressure source (e.g., a pump). The pressure source may control a pressure of the pressure chamber and may apply positive or negative pressures (e.g., a vacuum) to the pressure chamber. A pressure connection may comprise any suitable fitting or connector. A pressure connection is often configured to receive a suitable conduit (e.g., a tube, hose, pressure line, pipe, and the like) configured to provide positive or negative pressure to a pressure chamber (e.g., 120) of a lid (e.g., 102). In some embodiments, the pressure connection 104 may be configured to receive a quick-connect fitting. Of course, in other embodiments, the pressure connection 104 may be configured to receive a press fitting or another suitable pressure connection, as the present disclosure is not so limited. As will be discussed further below with reference to FIGS. 2-3, the lid is often configured to receive, manipulate and/or provide placement of a film on an object. As shown in FIG. 1, the base 150 is configured to receive and secure an object 250, which in the depicted embodiment comprises a well plate. The base will be discussed further below with reference to FIGS. 10-11.

FIG. 2 is a bottom perspective view and FIG. 3 is a bottom view of the lid 102 of the assembly of FIG. 1. As shown in FIGS. 2-3, the lid has been inverted relative to its position shown in FIG. 1. As shown in FIG. 2, the lid comprises a body 101 and a surface 108 of the body that is configured to receive a film. In some embodiments, the surface 108 is a substantially planar surface that is substantially flat. The surface may have a surface flatness tolerance within 50 microns. The surface comprises a plurality of vent openings 109, which in the depicted embodiments are configured as holes. As shown in FIGS. 2-3, the vent openings are arranged in an array of rows and columns. The plurality of vent openings may be configured to be aligned with walls of an object (e.g., a well plate) to which the film is to be secured. The vent openings are fluidly connected to a pressure chamber of the lid, such that air (or another gas) may flow between the pressure chamber and the plurality of vent openings. The vent openings are configured to apply positive or negative pressure to a film disposed on the surface 108. In some embodiments, the size of the vent openings is based on the thickness and weight of the film. In these embodiments, if the film is very thin or soft, then smaller vent openings may be employed because large vent openings would cause one or more dimples in the film because the film is drawn into the large vent opening(s) by the negative pressure applied to the film. In some embodiments, the size of the vent openings ranges from 50-500 um. In some embodiments, the spacing and number of vent openings depends on size and weight of the film and features of the object. For example, in some embodiments, the distance between the vent opening ranges from approximately 2 mm to 25 mm. In some embodiments, the number of vent openings is selected to obtain a distribution of air to hold the film flat and to ensure that pressure is evenly distributed when the film is applied to the object. In some embodiments, the pressure applied to the vent openings is adjusted based on characteristics of the film, such as the material of the film. For example, in some embodiments, the pressure applied (e.g., by a vacuum) ranges from 25-20 Hg and/or 1-3 PSI.

In some embodiments as shown in FIG. 3, the application of positive or negative pressure may be controlled using a switch 118. Of course, any suitable user interface may be employed on a lid, as the present disclosure is not so limited. According to the embodiment of FIGS. 2-3, the surface 108 is rectangular, which may match a shape of the film.

As shown in FIGS. 2-3, the lid 102 comprises a plurality of pegs 110. In particular, the lid comprises four pegs 110. In some embodiments, a different number of pegs can be used, as the present disclosure is not so limited. In some embodiments, the pegs 110 are steel dowel pins. In some embodiments, the width and height of the pegs 110 are based on the object and the lid. For example, the width and/or height of the pegs may be based on how low the lid needs to be guided down. For example, in some embodiments, the pegs 110 can range in diameter from ˜0.3 inches to 0.5 inches and in height from 0.375 inches to 2 inches. In some embodiments, no pegs are used and an alignment protrusion is integrated into the lid (e.g., a machined fin, protrusion).

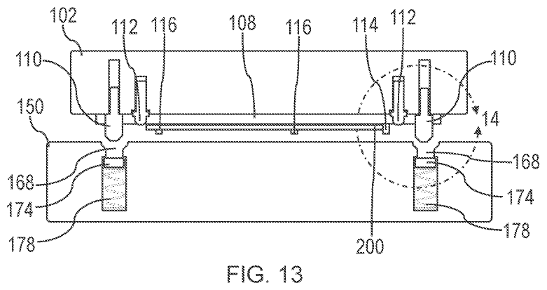

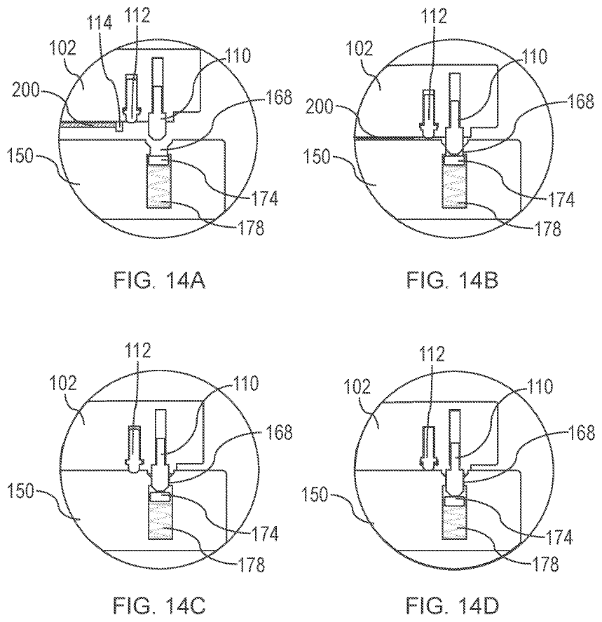

The pegs are configured to be received in corresponding receptacles of a base. The pegs and corresponding receptacles are configured to align the lid relative to the base when the pegs are received in the receptacles. Additionally, the pegs and receptacles may be configured to restrict relative movement of the lid and the base to a single axis (e.g., parallel to an insertion or removal direction). Accordingly, when the pegs are received in the receptacles, the surface 108 may be moved toward or away the base, but the surface may not be moved transversely or rotated relative to the base. In this manner, the pegs maintain the alignment of the lid with the base. As shown in the embodiment of FIGS. 2-3, the pegs 110 comprise lead-ins 111 configured to urge the lid into alignment with a base. In some embodiments, as shown in FIGS. 2-3, the pegs 110 are each disposed adjacent a corner of the surface 108. According to the embodiment of FIGS. 2-3, the lid also comprises a plurality of spring pins 112. The spring pins 112 may function as a soft stop to maintain a minimum spacing between the lid and a base until a threshold force is applied to the lid in the direction of the base. Thus the spring pins 112 can prevent the lid from pre-maturely contacting the base. The number of spring pins 112 can be based on the size of the lid and/or base. In some embodiments, the spring pins 112 are spaced apart to ensure stability, with more spacing between the spring pins 112 creating more stability. Functionality of spring pins is discussed further with reference to the exemplary embodiment of FIGS. 14A-14D. In other embodiments, no spring pins may be employed, as the present disclosure is not so limited.

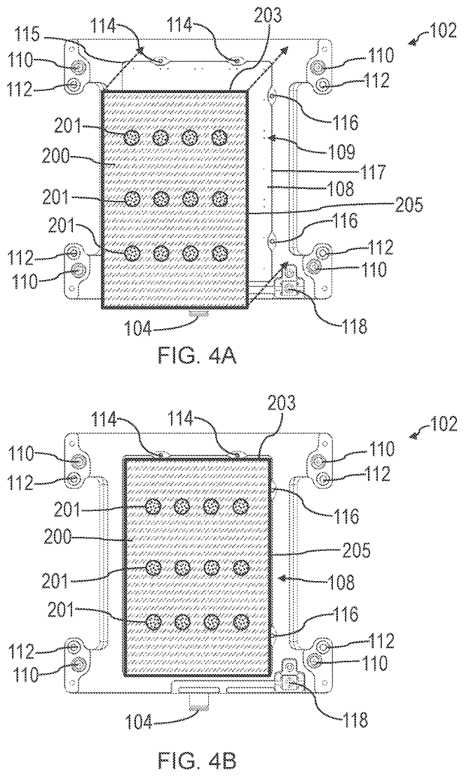

As shown in FIGS. 2-3, the lid 102 comprises first alignment protrusions 114 and second alignment protrusions 116. The first alignment protrusions are two protrusions disposed on a first border 115 of the surface 108. The second alignment protrusions are two protrusions disposed on a second border 117 of the surface 108. Of course, in other embodiments, any suitable number of protrusions may be employed, as the present disclosure is not so limited. The protrusions can be any shape, such as square, round, etc., and any material, such as metal, plastic, etc. For example, in some embodiments, the protrusions are steel dowel pins approximately 0.125 inches in diameter and approximately 0.5 inches tall. In some embodiments, the protrusions extend a minimal amount from the surface, and thus, a minimal amount beyond the film. For example, in some embodiments, the protrusions extend 0.05-0.1 inches beyond the film. In some embodiments, the protrusions are integrated into the lid. As shown in FIG. 3, the first border and second border are transverse (e.g., perpendicular) to one another and form a corner of the surface. Accordingly, the first alignment protrusions 114 and second alignment protrusions 116 provide two directions in which the edges of a film may be pressed against the alignment protrusions while disposed on the surface 108. When the first edge of the film abuts the first alignment protrusions 114 and the second edge of the film abuts the second alignment protrusions 116 and the film is disposed against surface 108, the position of the film relative to the surface may be known without measurement. Additionally, as the spacing between the pegs 110 and the alignment protrusions 114, 116 is predetermined, alignment between the film and a corresponding base is ensured. Examples of using alignment protrusions to align a film with a lid are discussed further with reference to FIGS. 4A-4B.

FIG. 4A depicts a lid 102 and one embodiment of a film 200 in a first state, and FIG. 4B depicts the lid and film in a second state. As shown in FIG. 4A, the lid 102 is the lid of FIG. 3, and comprises first protrusions 114 and second protrusions 116 aligned with a first border 115 and a second border 117 of a surface 108, respectively. As shown in FIG. 4A, the film is disposed on the surface 108 but is not abutting the alignment protrusions 114, 116. The film 200 may comprise a plurality of molecular arrays 201 disposed on the film which may be sensitive to physical spacing error between the film and an object to which the film is secured (e.g., a well plate). Accordingly, it may be desirable to move the film to a known position relative to the lid 102 so that the lid may be employed to secure the film to the object while the film is in the known position. As shown in FIG. 4A, the film 200 may be moved in a direction toward the first alignment protrusions 114 and the second alignment protrusions 116, as shown by the dashed arrows. That is, the film moves toward a corner defined by the first border 115 and the second border 117. In some embodiments, a positive pressure may be applied to the film via the plurality of vent openings 109, so as to reduce friction and/or static cling restricting the motion of the film. In some embodiments, the film 200 may move in a planar direction parallel to a plane defined by the surface 108.

FIG. 4B depicts the end result of the movement of the film shown in FIG. 4A. The film abuts the first alignment protrusions 114 and the second alignment protrusions 116. In particular, a first edge 203 of the film abuts the first alignment protrusions 114 and a second edge 205 of the film abuts the second alignment protrusions 116. Once the first edge 203 of the film abuts against the first alignment protrusions 114, the film can no longer move in a direction toward the first alignment protrusions. Likewise, once the second edge 205 of the film abuts the second alignment protrusions 116, the film can no longer move in a direction toward the second alignment protrusions. Accordingly, movement of the film is constrained in two directions that may define the plane occupied by the film, and the position is therefore known as the first edge 203 and second edge 205 of the film are aligned with the first border 115 and second border 117, respectively. Once the film is in the position shown in FIG. 4B, a negative pressure may be applied to the film via the plurality of vent openings 109 to secure the film to the surface 108 in the known position.

It should be noted that while in the embodiments of FIGS. 2-4B depict alignment protrusions aligned with a physical border of a surface, in other embodiments the alignment protrusions and physical border of the surface may not be aligned. For example, in some cases, the alignment protrusions may extend from an internal portion the surface, such that the alignment protrusions are disposed inward of the physical border of the surface. In another example, the alignment protrusions may be disposed outward of the physical border of the surface. According to this example, a film may overhang the physical border of the surface while abutting the alignment protrusions. In this manner, the alignment protrusions may define an effective border of the surface, as a film is unable to pass the alignment protrusions while disposed on the surface.

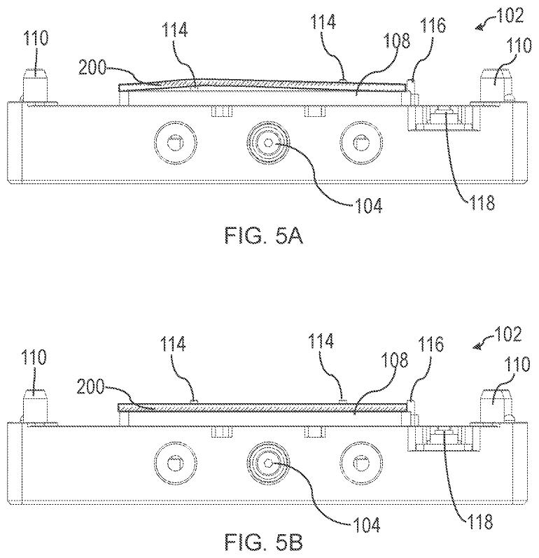

FIG. 5A depicts a side view of the lid 102 of FIG. 2 and another embodiment of a film 200 in a first state, and FIG. 5B depicts the lid and film in a second state. In particular, FIGS. 5A-5B depict a process of flattening a film against a surface 108 so that a consistent film shape may be secured to an object (e.g., a well plate). In the state of FIG. 5A, the film 200 may be unsecured to the surface 108. For example, FIG. 5A may be representative of when the film is first placed on the surface 108 before any negative pressure is applied. As another example, FIG. 5A may be representative of when the film is moved into abutment with alignment protrusions 114, 116, but before negative pressure is applied to secure the film to the surface 108. Accordingly, in the state of FIG. 5A, the film 200 is resting on the surface 108 in an unstressed state. As shown in FIG. 5A, the film is not flush with the surface 108. The film is instead slightly warped and a portion of the film may be spaced from the surface, which may be common in rigid films having a thickness between 50 and 500 microns.

FIG. 5B depicts the film 200 flattened against the surface 108. In FIG. 5B, a negative pressure (e.g., a vacuum) is being applied to the film via a plurality of vent openings via the pressure connection 104. Accordingly, application of this negative pressure forces the film 200 into engagement with the surface 108. As a result, the forces elastically deform the film to adopt the shape of the surface 108, which in the present embodiment is planar. The surface 108 may be substantially flat, such that the deformed film 200 is also substantially flat. Once in the state shown in FIG. 5B, the film may be secured to an object such as a well plate, which may permanently retain the film in the flattened state (e.g., with adhesives).

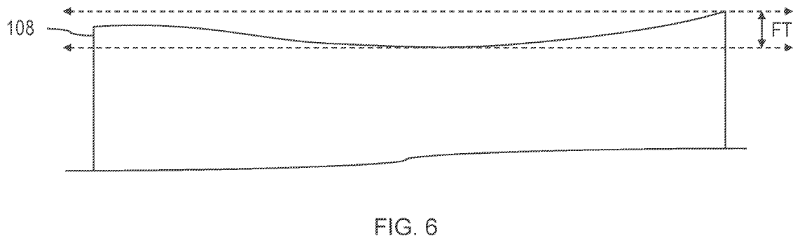

FIG. 6 is an illustration of a schematic of one embodiment of a film receiving surface 108 of a lid. The view shown in FIG. 6 is an enlarged view of a top portion of a film receiving surface for illustration purposes only. Accordingly, a surface of exemplary embodiments herein may not be visibly curved as shown in FIG. 6. As shown in FIG. 6, the surface may have a flatness tolerance FT which is defined as the distance between two parallel planes in between which an entire surface profile lies. Put alternatively, the flatness tolerance is the difference between the lowest point on the surface and the highest point of the surface. As discussed previously, the flatness tolerance may be relevant to achieve a desired flatness of a film. For example, in some embodiments, the surface 108 may have a flatness tolerance within 100 microns, 75 microns, 50 microns, 25 microns, 10 microns, 5 microns, or another suitable distance. When a vacuum is applied to a film disposed on the surface as shown in FIG. 5B, the film will approach if not match the flatness of the surface 108.

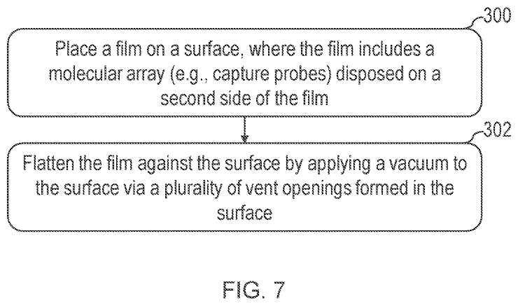

FIG. 7 is a flow chart for one embodiment of a method of securing a film to an object. In block 300, a film is placed on a surface (e.g., of a lid). According to the embodiment of FIG. 7, the film comprises a molecular array (e.g., capture probes) disposed on a first side of the film. In some embodiments, a second opposing side of the film may be placed on the surface, so that the capture probes are not disturbed. In some embodiments the plurality of capture probes may be organized into an array. In some embodiments, the capture probes may be immobilized oligonucleotide probes. In block 302, the film is flattened against the surface by applying a vacuum to the surface via a plurality of vent openings formed in the surface. For example, a pressure source may extract air from a pressure chamber fluidly connected to the plurality of vent openings. Flattening the film may comprise elastically deforming the film against the surface. In some embodiments, the method may also comprise placing the flattened film onto an object such as a well plate and securing the flattened film against the object to retain the film in the flattened configuration.

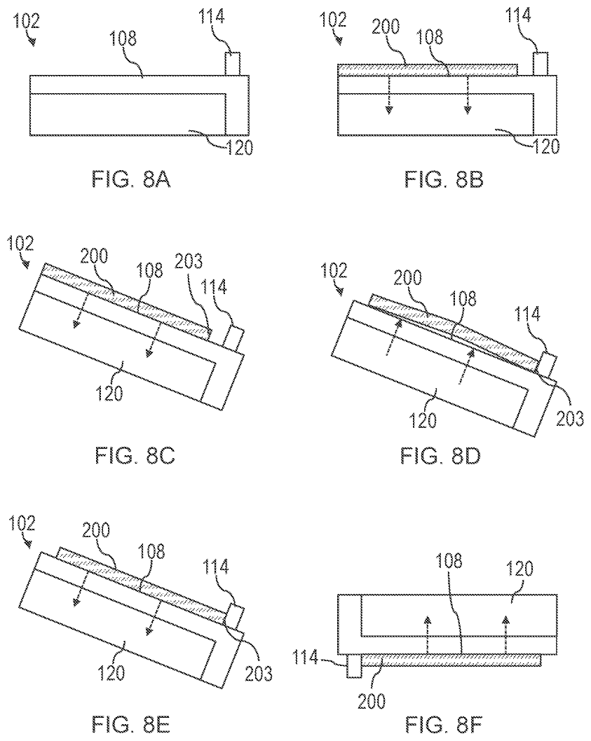

FIGS. 8A-8F depict schematics of a process of aligning and flattening a film relative to a lid 102. As shown in FIG. 8A, the lid comprises a surface 108 and an alignment protrusion 114 extending past the surface 108. The lid also comprises a pressure chamber 120 fluidly connected to a pressure source and configured to apply positive or negative pressure to a film via a plurality of openings (for example see FIGS. 2-3). As shown in FIG. 8B, a film 200 is placed on the surface 108 and secured to the surface by applying a negative pressure to the film, as shown by the dashed arrows. In FIG. 8C, the lid 102 is tilted relative to a horizontal plane. Accordingly, the surface 108 is positioned as an incline plane in the state shown in FIG. 8C. However, in the state shown in FIG. 8C, the film 200 remains stationary relative to the surface 108 as the negative pressure is still applied to the film. In FIG. 8D, the pressure is reversed so that a positive pressure is applied to the film 200 to lift the film from the surface 108. Accordingly, the film may return to an unstressed shape that may not be parallel to the surface 108. As the film is no longer secured by the negative pressure, the film slides under the effect of gravity until the edge 203 of the film abuts against the alignment protrusion 114 which stops further movement of the film. Accordingly, the position of the film relative to the alignment protrusion 114 is known. In FIG. 8E, the pressure is reversed again such that the film 200 is secured to the surface 108 again. As shown in FIG. 8E, the film is flattened against the surface 108, similar to the shape shown in FIGS. 8B-8C. However, as shown in FIG. 8E, the film 200 remains in engagement with the alignment protrusion 114 so that the position of the film remains known. As shown in FIG. 8F, the negative pressure applied to the film 200 may retain the film against the surface even when the lid 102 is inverted. In some embodiments, a lid may be coupled to a base in an inverted orientation.

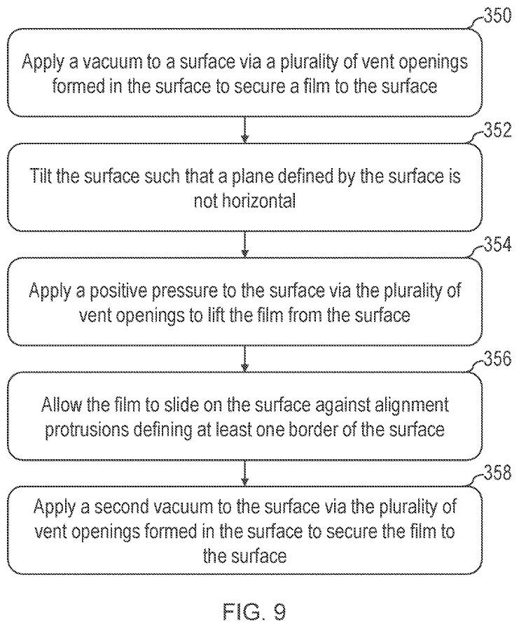

FIG. 9 is a flow chart for another embodiment of a method of securing a film to an object at least partially corresponding to the process shown in FIGS. 8A-8F. In block 350, a vacuum is applied to a surface via a plurality of vent openings formed in the surface to secure the film to the surface. In block 352, the surface is tilted such that a plane defined by the surface is not horizontal. In block 354, a positive pressure is applied to the surface via the plurality of vent openings to lift the film from the surface. In some alternative embodiments, a positive pressure may not be applied, but instead the negative pressure may be released (e.g., so that a net zero pressure is applied to the film). In block 356, the film is allowed to slide along the tilted surface until an edge of the film abuts against alignment protrusions defining at least one border of the surface. In block 358, a second vacuum is applied to the surface via the plurality of vent openings to secure the film to the surface. This second vacuum is configured to secure the film in a known position based on abutment between the alignment protrusions and the film.

FIG. 10 is a perspective view of a base 150 of the assembly of FIG. 1. As shown in FIG. 10, the base comprises a cavity 152 configured to receive and retain an object such as a tray. In some embodiments, as shown in FIG. 10, the cavity comprises two grooves 154 forming a track for an object, such as a tray. The base comprises upper plates 156 defining an upper wall of the grooves 154. In some embodiments, the upper plates 156 may be formed of metal, though other materials are contemplated. Of course, in other embodiments, grooves may not comprise plates, as the present disclosure is not so limited. As shown in FIG. 10, the grooves may comprise lead-ins 155 which may assist in aligning an object within the cavity 152. According to the embodiment of FIG. 10, the cavity comprises a stop 158 configured to abut an object such as a tray. The abutment of the tray with the stop 158 may position the tray in a known position relative to the base 150.

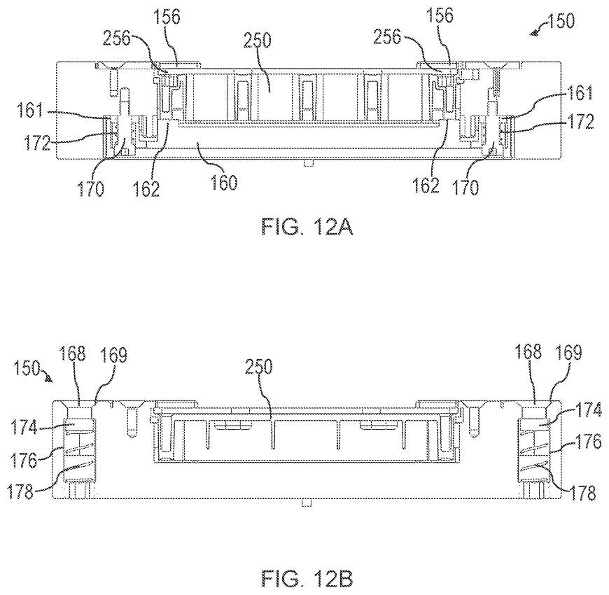

According to the embodiment of FIG. 10, the tray may comprise retainers 160 configured to retain an object such as a tray in the cavity 152. In particular, the retainers are configured to retain the object in a known position (e.g., in abutment with the stop 158) so that a film may be accurately secured to the object. In the embodiment of FIG. 10, the retainers extend into the cavity and are configured to apply force to an object to force the object into abutment with the upper plates 156. In particular, as shown in FIG. 10, the retainers comprise inclined clips 162 configured to apply force to an object disposed in the cavity 152. The inclined clips are inclined such that movement of the object parallel to the grooves 154 retracts the retainers and allow the object to move into abutment with the stop 158. The specific movement of the retainers 160 into and out of the cavity 152 to apply force to the object is discussed further with reference to FIG. 12A. In some embodiments, as shown in FIG. 11, the base may comprise a pressure connection 164 configured to be fluidly connected to a pressure source. The pressure connection 164 may move various components of the base with pressure. For example, in some embodiments the retainers 160 may be moved into and/or out of the cavity 152 with pressure from a pressure source.

As shown in FIG. 10, the base comprises a plurality of receptacles 168 each configured to receive a peg of a lid. In particular, the base comprises four receptacles 168 configured to receive four corresponding pegs. As discussed previously, the pegs and corresponding receptacles are configured to align the lid relative to the base when the pins are received in the receptacles. Additionally, the pins and receptacles are configured to restrict relative movement of the lid and the base to a single axis (e.g., parallel to an insertion or removal direction). Accordingly, when the pegs are received in the receptacles, the base may not be moved transversely or rotated relative to the lid. In this manner, the pegs maintain the alignment of the lid with the base. As shown in the embodiment of FIGS. 2-3, the receptacles 168 comprise lead-ins 169 configured to urge the lid into alignment with a base. In some embodiments, the lead-ins of the receptacles may correspond to lead-ins of pegs. In some embodiments, as shown in FIG. 10, each of the receptacles 168 is disposed adjacent a corner of the cavity 152.

FIG. 11 is a perspective view of the base 150 of FIG. 10 and one embodiment of an object 250 (e.g., a tray). As shown in FIG. 11, the object 250 is disposed and retained in the cavity 152 of the base. The tray of FIG. 11 is configured as a well plate and comprises a plurality of wells 252 separated by walls 254. In the embodiment of FIG. 11, the tray comprises a lip 256. The lip of the tray is configured to be received in the two grooves 154 to constrain the movement of the tray. That is, the grooves may inhibit the tray from moving in any direction other than an insertion direction or removal direction (e.g., parallel to the grooves). Of course, in other embodiments, a base may receive and retain an object within a cavity without grooves, as the present disclosure is not so limited. For example, latches, interference fits, detents, and/or any other appropriate retainer may be employed to retain the tray within the cavity 152.

FIG. 12A is a cross-sectional view of the base 150 of FIG. 11 taken along line 12A-12A. The cross-section of FIG. 12A comprises a retainer 160 that is engaged with an object 250 to retain the tray in a known position within the base. In some embodiments, as shown in FIG. 12A, the retainer is configured to move between an engaged position where the retainer extends into the cavity and a retracted position where the retainer does not extend into the cavity. In the state shown in FIG. 12A, the retainer is in the engaged position where the retainer is engaged with the object 250. In the embodiment of FIG. 12A, two inclined clips 162 are engaged with a bottom surface of the object 250. As shown in FIG. 12A, the retainer is biased toward the engaged position, such that the retainer automatically moves into engagement with the object 250 when the tray is placed in the base. As shown in FIG. 12A, the retainer is secured to the base via fasteners 170 that allow the retainer to move between the engaged and disengaged positions. The base also comprises compression springs 172 disposed between a head of the fasteners and a tab 161 of the retainer. The compression springs apply force to the retainer (e.g., in an upward direction relative to the page) to bias the retainer to the engaged position. Of course, in other embodiments, any suitable biasing arrangement may be employed, as the present disclosure is not so limited. The retainer 160 is configured to apply force against the tray, forcing the tray into the upper plates 156. This force may secure the tray in a desired position (e.g., via static friction). In some embodiments, to remove the tray from the base, the retainer 160 may be moved from the engaged position to the disengaged position. For example, in some embodiments, a lever may be employed by a user to move the retainer to the disengaged position against the force of the springs 172. As another example, in some embodiments, pressure (e.g., from a pressure source) may be employed to move the retainer to the disengaged position. In other embodiments, the tray may be removable from the base upon application of a threshold force to the tray.

FIG. 12B is a cross-sectional view of the base 150 of FIG. 11 taken along line 12B-12B. FIG. 12B depicts an arrangement of two receptacles 168 of the base. As shown in FIG. 12B, in some embodiments, a receptacle may comprise a plunger 174 and a spring 178 disposed in a chamber 176. The plunger 174 may be configured to engage a peg of a lid, and resist movement of the peg into the receptacle. That is, movement of a peg into the receptacle may compress the spring 178, generating a biasing force urging the peg out of the receptacle. The inventors have appreciated that such an arrangement may help to avoid unintentional contact between a film disposed on a lid and an object 250 disposed on the base. That is, a user may couple a lid to the base without the lid falling into full engagement with the base, as the plungers 174 keep portions of the lid spaced from the base. Accordingly, application of a first threshold force by a user may move the lid into full engagement with the base against the biasing force of the springs 178. Once the threshold force is released by the user, the plungers 174 may automatically move the lid away from the base. In some embodiments as will be discussed with reference to FIGS. 13-14D, in some embodiments, a lid may comprise spring pins which may require an additional second threshold force larger than the first threshold force to bring a film into contact with a tray. Such an arrangement may further reduce the chance for unintentional contact between a film and a tray.

FIG. 13 is a side schematic of an embodiment of an assembly for securing a film 200 to an object such as a tray. In particular, the assembly of FIG. 13 comprises a lid 102 and a base 150. Similar to embodiments previously discussed, the lid comprises a surface 108 configured to receive and retain the film 200 (e.g., via application of a negative pressure to the surface). The film is configured to be aligned on the surface 108 via abutment with alignment protrusions 114, 116. As shown in FIG. 13, the lid also comprises pegs 110 configured to be received in receptacles 168 of the base 150. In the embodiment of FIG. 13, the base comprises a plunger 174 and spring 178 disposed in the receptacle. The plunger and spring are configured to bias the lid 102 away from the base 150 when the pegs 110 are received in the receptacles. The plunger 174 and spring 178 may also prevent contact between the film 200 and an object unless a first threshold force is applied to the lid in an insertion direction. The first threshold force may overcome the biasing force of the receptacle springs 178.

In some embodiments, as shown in FIG. 13, the lid 102 comprises one or more spring pins 112. The spring pins may be configured to engage an upper surface of the base 150 and maintain a spacing between the lid and the base until a second threshold force is applied. That is, the spring pins 112 may be stiffer than the receptacle springs 178, such that additional force is employed to move the spring pins to a retracted position. When the second threshold force is applied in an insertion direction, the film 200 may be moved into engagement with an object disposed in the base 150. In this manner, the combination of the spring pins 112 and the receptacle springs 178 may provide a two-stage process to ensure that contact between film and an object is intentional. Similar to the receptacle springs 178, the spring pins may move the lid 102 away from the base when the second threshold force is released. A process of using the lid and base of FIG. 13 is shown and described further with reference to FIGS. 14A-14D.

FIGS. 14A-14D depict an enlarged view of section 14 of the assembly of FIG. 13 in several states through a process of securing a film 200 to an object disposed in the base 150. In FIG. 14A, the lid 102 is spaced from the base 150, and the peg 110 is not received in the receptacle 168. In FIG. 14B, the lid 102 is coupled to the base 150 and the peg is received in the receptacle 168. The state of FIG. 14B may be representative of a resting state where no additional force (other than gravity) is applied to the lid 102 in an insertion direction. Accordingly, the receptacle spring 178 maintains the position of the lid 102 above the base 150 where the film is not in contact with an object disposed in the base. FIG. 14C depicts a third state where a first threshold force is applied to the lid in an insertion direction. Upon application of the first threshold force, the lid is moved closer to the base, and the peg 110 is moved further into the receptacle against the biasing force applied by the receptacle spring 178 and plunger 174. The lid 102 is still held slightly spaced from the base by the spring pin 112. Accordingly, the film may be correspondingly spaced from the base by the spring pin. FIG. 14D depicts a fourth state where a second threshold force greater than the first threshold force is applied to the lid in an insertion direction. Upon application of the second threshold force, the lid is moved into full engagement with the base. Correspondingly, the peg 110 is moved further into the receptacle 168 against the biasing force applied by the receptacle spring 178 and plunger 174. The spring pin 112 is moved to a retracted position within the lid. The state of FIG. 14D may correspond to the film being brough into contact with an object disposed in the base, such that the film may be secured to the object.

It should be noted that while in some embodiments, two threshold forces may be applied to a lid to bring a film into engagement with an object, it should be appreciated that any suitable number of threshold forces may be applied in any number of stages, as the present disclosure is not so limited. For example, in some embodiments, a lid may not comprise spring pins, such that a single threshold force is applied to the lid to bring a film into engagement with an object. In other embodiments, a base may not comprise a plunger and spring, such that a threshold force for overcoming a spring pin may be the only force employed to bring a film into engagement with an object. In this manner, any suitable biasing members may be employed to avoid incidental contact between a film and an object. Of course, in some embodiments, no biasing members may be employed. Additionally, it should be noted that spring pins, plungers, and receptacle springs may be employed on a lid and/or base interchangeably, as the present disclosure is not so limited in this regard.

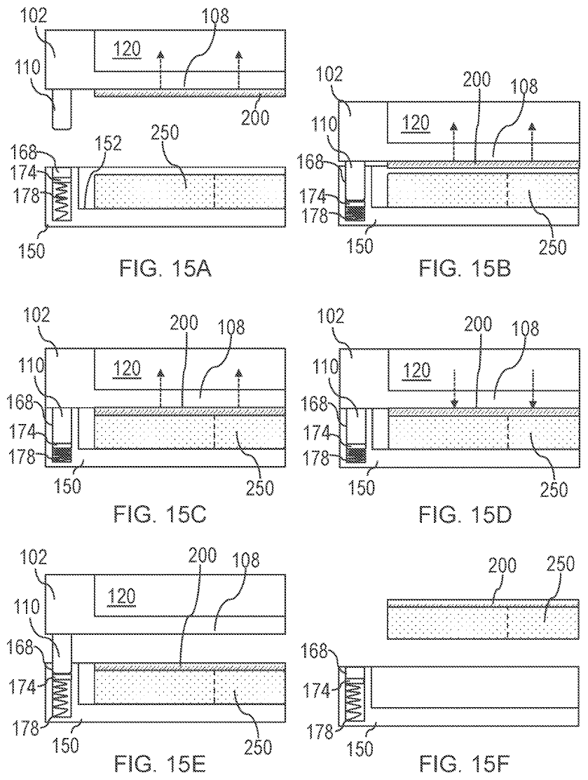

FIGS. 15A-15F depict a schematic of one embodiment of an assembly for securing a film 200 to an object 250 through several states of securing the film to the object. In particular, FIGS. 15A-15F depict the use of pressure applied to a film via a lid 102 to secure the film to the object. As shown in FIG. 15A, the lid 102 comprises a pressure chamber 120 and a surface 108. In some embodiments, the pressure chamber 120 is a single chamber. In some embodiments, the pressure chamber 120 is a manifold. In some embodiments, the pressure chamber 120 is a plurality of tubes. The pressure chamber 120 may be connected (e.g., fluidly) to one or more pressure sources and may be configured to apply positive or negative pressure to the surface 108 (e.g., via one or more vent openings). The surface receives the film 200 which may be secured to the surface via application of a negative pressure to the surface, as shown by the dashed arrows in FIG. 15A. Accordingly, the film may be held on the surface even though the lid 102 is inverted and the film would otherwise fall off the surface 108 under the effect of gravity. As shown in FIG. 15A, the lid comprises a peg 110. The assembly of FIGS. 15A-15F also comprises a base 150. The base comprises a cavity 152 which receives and retains the object 250 (e.g., a well plate). In the embodiment of FIGS. 15A-15F, the base also comprises a receptacle 168 configured to receive the peg 110 so that the lid may be aligned relative to the base 150. The receptacle 168 comprises a plunger 174 and receptacle spring 178 configured to bias the peg 110 out of the receptacle. Accordingly, the plunger and receptacle spring 178 are configured to maintain a spacing between the lid 102 and the base until a threshold force is applied to the lid 102 in an insertion direction (e.g., toward the base).

FIG. 15B depicts the lid 102 coupled to the base 150. In FIG. 15B, the peg 110 is received in the receptacle 168. Additionally, the weight of the lid 102 and/or a force applied to the lid (e.g., by a user or machine) compresses the receptacle spring 178. However, a threshold has not been applied to the lid 102 in the state of FIG. 15B, such that the film 200 remains spaced from the object 250. In the state of FIG. 15B, a negative pressure is still applied to the film 200 to retain the film on the surface 108. In FIG. 15C, a threshold force has been applied to the lid 102 in an insertion direction. Accordingly, the lid has moved closer to the base such that the film 200 is in engaged with the object 250. In some embodiments, an adhesive disposed on the object 250 may begin to bond with the film 200 to secure the film to the object. Once the threshold force has been applied, the pressure applied to the surface 108 may be inversed as shown in FIG. 15D. In particular, a positive pressure may be applied to the film 200 via the surface 108 to force the film into further engagement with the object 250. During this pressure change, the threshold force may be continually applied to the lid in order to hold the lid in position as the positive pressure is applied to the film. In some embodiments, the positive pressure may be between 1 and 4 psi. The application of positive pressure to the film may also release the film from the surface 108. Once the film 200 has sufficiently bonded with the object 250, the threshold force may be removed from the lid 102. Accordingly, the plunger 174 and receptacle spring 178 may move the lid 102 away from the base 150. As no negative pressure is applied to the film, the film may be deposited on the object and may not move with the lid during this stage of the process. The lid 102 may be subsequently removed from the base 150 as shown in FIG. 15F. Once the lid is removed from the base, the combined object 250 and film 200 may be removed from the base.

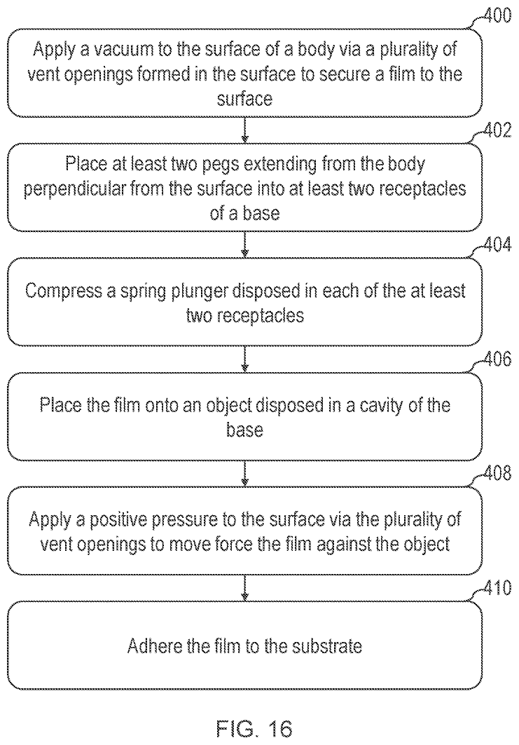

FIG. 16 is a flow chart for an embodiment of a method of securing a film to an object. The method shown in FIG. 16 may at least partially correspond to the process shown in FIGS. 15A-15F. In block 400, a vacuum is applied to the surface of a body via a plurality of vent openings formed in the surface to secure a film to the surface. In block 402, at least two pegs extending from the body may be placed into at least two receptacles of a base. The placement of the pegs into the receptacles may align the lid with the base. In block 404, a spring plunger disposed in each of the receptacles is compressed. In some embodiments, a single spring plunger may be employed, as the present disclosure is not so limited. In block 406, the film is placed onto an object disposed in a cavity of the base. In some embodiments, the object may be a tray such as a well plate. In block 408, positive pressure (e.g., 1-4 psi) may be applied to the film in a direction to move the film against the object. In block 410, the film is adhered to the substrate (e.g., with an adhesive).

FIG. 17 is a side schematic of another embodiment of an assembly for securing a film 200 to an object 250. In particular, FIG. 17 depicts an assembly for securing a film to an object with an adhesive curable with ultraviolet light. As shown in FIG. 17, the assembly comprises a lid 102 having a pressure chamber 120 configured to be fluidly connected to one or more pressure sources via a pressure connection 104. In some embodiments, the pressure chamber 120 is a single chamber. In some embodiments, the pressure chamber 120 is a manifold. In some embodiments, the pressure chamber 120 is a plurality of tubes. The lid also comprises a surface 108 configured to receive and retain the film 200, for example, by application of negative pressure or vacuum to the film. The vacuum may be applied to film via a plurality of vent openings 109. According to the embodiment of FIG. 17, the vent openings may be voids configured to allow ultraviolet light to pass through. In other embodiments, the surface 108 may be at least partially transparent so that ultraviolet light may pass though the surface 108. The lid comprises a plurality of ultraviolet light sources 180 that are configured to emit ultraviolet light toward the film 200. As shown by the arrows, the light may pass through the vent openings and may be incident on the film 200. The film 200 may also be at least partially transparent to ultraviolet light. Accordingly, the ultraviolet light may pass through the film to cure an adhesive disposed between the object and the film. Such an arrangement may simplify bonding of a film to an object, as the adhesive may be cured while the film is held on the object by the lid (e.g., via positive pressure, physical force, etc.) as discussed in reference to other exemplary embodiments herein.

As shown in the embodiment of FIG. 17, the film is disposed on several walls 254 of the object 250 and is unsupported in other areas. As shown in FIG. 17, the vent openings 109 are aligned with the walls 254 of the object 250, which may provide two benefits. First, pressure applied to the film via the vent openings is applied in a supported region of the film. Accordingly, forcing the film against the object may result in less bending of the film compared to pressure applied in unsupported regions of the film. Second, an adhesive joint between the object 250 and the film is disposed at the junction between the walls 254 and the film 200. Accordingly, the alignment of the vent openings directs the ultraviolet light from the light sources 180 toward the relevant adhesive joints for curing.

FIG. 18 is a side schematic of another embodiment of an assembly for securing a film 200 to an object 250. FIG. 18 depicts an assembly for securing a film to an object with an adhesive curable with heat. As shown in FIG. 18, the assembly comprises a lid 102 having a pressure chamber 120 configured to be fluidly connected to one or more pressure sources via a pressure connection 104. In some embodiments, the pressure chamber 120 is a single chamber. In some embodiments, the pressure chamber 120 is a manifold. In some embodiments, the pressure chamber 120 is a plurality of tubes. The lid also comprises a surface 108 configured to receive and retain the film 200, for example, by application of negative pressure or vacuum to the film. The surface comprises a plurality of heating elements 182 (e.g., resistive heaters) configured to generate heat within the surface. The heat may be transferred to the film 200 (e.g., via conduction) which may warm an adhesive joint between the film and the object. In some embodiments as shown in FIG. 18, the heating elements 182 may be aligned with a plurality of walls 254 of the object. According to this embodiment, heat may be concentrated at an adhesive joint between each of the walls and the film 200.

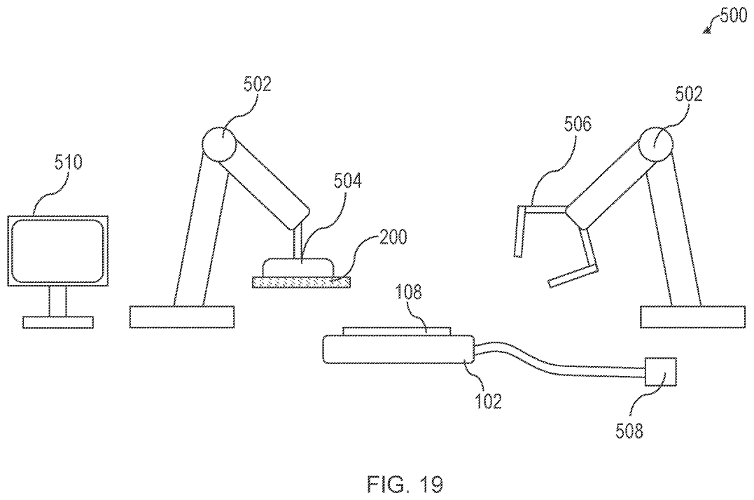

FIG. 19 is a schematic of another embodiment of an automated system 500 for securing a film 200 to an object. As shown in FIG. 19, the system comprises a plurality of grippers 502 configured to manipulate the various components of a system (e.g., a lid, base, film, object, etc.). As shown in FIG. 19, one gripper comprises a vacuum attachment 504 configured to pick and place films 200 by applying a vacuum to the film. Another gripper comprises a grasping attachment 506 configured to grip and position components of the system. As shown in FIG. 19, the system comprises a lid 102 having a surface configured to receive the film 200. The lid is connected to a pressure source 508 that is configured to apply positive or negative pressure to the surface 108. A system according to FIG. 19 may be configured to perform the exemplary methods described herein. The system may be controlled by one or more processors, for example, of a computer 510. In some embodiments, a user may monitor, provide input, or otherwise control the system via the computer (e.g., a user interface).

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A device comprising:
a body comprising a surface configured to receive a film;
one or more alignment protrusions disposed on at least one border of the surface, wherein the one or more alignment protrusions extend past the surface;
a pressure chamber disposed in the body; and
a plurality of vent openings formed in the surface, wherein the plurality of vent openings is in pneumatic connection with the pressure chamber, and wherein the vent openings of the plurality of vent openings are configured to apply a negative pressure to the surface to flatten the film against the surface as the negative pressure is provided to the pressure chamber, optionally comprising a pressure source pneumatically connected to the pressure chamber, wherein the pressure source is configured to provide the negative pressure to the pressure chamber.

2. (canceled)

3. The device of claim 1, wherein the surface is substantially flat, and has a flatness tolerance within 50 microns.

4-6. (canceled)

7. The device of claim 1,
wherein (i) the plurality of vent openings is arranged in an array on the surface,
wherein the array of vent openings comprises a plurality of columns and a plurality of rows, or (ii) the one or more alignment protrusions are configured to receive the film to align the film on the at least one border of the surface, and
wherein the one or more alignment protrusions are disposed on a first border and a second border of the surface.

8-14. (canceled)

15. The device of claim 1, wherein the surface is at least partially transparent to ultraviolet light.

16. The device of claim 15, further comprising (i) an ultraviolet light source disposed in the body, wherein the ultraviolet light source is configured to emit ultraviolet light through the surface, or (ii) a heat source configured to heat the surface.

17-19. (canceled)

20. A device comprising:
a film comprising a molecular array disposed on a first side of the film;
a body comprising a surface, wherein a second side of the film is disposed on the surface;
a pressure chamber disposed in the body; and
a plurality of vent openings formed in the surface, wherein the plurality of vent openings is in pneumatic connection with the pressure chamber, and wherein the vent openings of the plurality of vent openings are configured to apply a negative pressure to the surface to flatten the film against the surface as the negative pressure is provided to the pressure chamber, further comprising a pressure source pneumatically connected to the pressure chamber, wherein the pressure source is configured to provide the negative pressure to the pressure chamber, and wherein the film comprises glass having a thickness of less than 500 microns.

21-23. (canceled)

24. The device of claim 20, wherein the molecular array comprises a plurality of capture probes, wherein the plurality of capture probes comprises a plurality of immobilized oligonucleotide probes.

25-26. (canceled)

27. The device of claim 20, wherein the surface has a flatness tolerance within 50 microns.

28-30. (canceled)

31. The device of claim 20, wherein the surface is at least partially transparent to ultraviolet light, wherein the device further comprises an ultraviolet light source disposed in the body, wherein the ultraviolet light source is configured to emit ultraviolet light through the surface, and wherein the device further comprises heat source configured to heat the surface.

32-33. (canceled)

34. An assembly for securing a film to a tray, the assembly comprising:
a lid comprising:
a body comprising a surface configured to receive the film,
a pressure chamber disposed in the body,
a plurality of vent openings formed in the surface, wherein the plurality of vent openings is in pneumatic connection with the pressure chamber, and
at least two pegs extending from the body in a direction perpendicular from the surface; and
a base comprising:
a cavity configured to receive and support the tray, and
at least two receptacles configured to receive the at least two pegs of the lid,
wherein the assembly further comprises a pressure source in pneumatic communication with the pressure chamber, wherein the pressure source is configured to provide a negative pressure or positive pressure to the pressure chamber.

35. (canceled)

36. The assembly of claim 34, wherein the at least two pegs comprise peg lead-ins configured to align the at least two pegs with the at least two receptacles and wherein the at least two receptacles comprise receptacle lead-ins configured to align the at least two pegs with the at least two receptacles.

37-39. (canceled)

40. The assembly of claim 34, wherein the surface is substantially flat and the surface has a flatness tolerance within 50 microns.

41-42. (canceled)

43. The assembly of claim 34, wherein each of the at least two receptacles comprise a spring plunger configured to bias the lid away from the base when the at least two pegs are received in the at least two receptacles, and wherein the spring plunger comprises a plunger and a compression spring configured to apply force to the plunger.

44-47. (canceled)

48. The assembly of claim 34, wherein the lid further comprises one or more alignment protrusions disposed on at least one border of the surface, wherein the one or more alignment protrusions extend past the surface, and wherein the one or more alignment protrusions extend in a direction distal to the surface and/or in a direction perpendicular to the surface.

49-54. (canceled)

55. The assembly of claim 34, wherein the surface is transparent to ultraviolet light, and the assembly further comprises an ultraviolet light source disposed in the body, wherein the ultraviolet light source is configured to emit ultraviolet light through the surface toward the cavity when the at least two pegs are received in the at least two receptacle.

56-57. (canceled)

58. A method of securing a film to an object, the method comprising:
placing a first side of the film on a surface of a body, wherein the film comprises a molecular array disposed on a second side of the film; and
flattening the film against the surface by applying a vacuum to the surface via a plurality of vent openings formed in the surface, wherein the film is glass having a thickness of less than 500 microns, and wherein the molecular array comprises a plurality of capture probes and the plurality of capture probes comprises a plurality of immobilized oligonucleotide probes.

59-62. (canceled)

63. The method of claim 58, further comprising ejecting the film from the surface by applying a positive pressure to the surface via the plurality of vent openings to lift the film from the surface, and further comprising: tilting the surface such that a plane defined by the surface is not horizontal; applying a positive pressure to the surface via the plurality of vent openings to lift the film from the surface; allowing the film to slide on the surface against alignment protrusions disposed on at least one border of the surface, wherein the alignment protrusions extend past the surface; and applying a second vacuum to the surface via the plurality of vent openings formed in the surface to secure the film to the surface.

64. (canceled)

65. The method of claim 63, wherein the alignment protrusions extend in a direction distal to the surface, and wherein the alignment protrusions extend in a direction perpendicular to the surface, wherein the surface is substantially flat and has a flatness tolerance within 50 microns, wherein the method further comprises placing at least two pegs extending from the body in a direction perpendicular from the surface into at least two receptacles of a base, and wherein placing the at least two pegs in the at least two receptacles comprises compressing a spring plunger disposed on each of the at least two receptacles.

66-72. (canceled)

73. The method of claim 58, wherein the object is a tray, further comprising applying a positive pressure to the surface via the plurality of vent openings to move the film against the tray, wherein the positive pressure is between 1 and 4 psi.

74. The method of claim 73, further comprising adhering the film to the tray, wherein adhering the film to the tray comprises emitting ultraviolet light from an ultraviolet light source disposed in the body through the surface toward the tray, and wherein adhering the film to the tray comprises heating the film with a heat source disposed in the body.

75-79. (canceled)
